(19) United States
(12) Patent Application Publication
(10) Pub. No.: US 2002/0132969 A1
(43) Pub. Date: Sep. 19, 2002

(54) Cationic electrodeposition coating composition comprising phosphonium group-containing compound

(75) Inventor: Hiroyuki Nojiri, Osaka (JP)

Correspondence Address: SUGHRUE MION, PLLC, 2100 Pennsylvania Avenue, N.W., Washington, DC, 20037-3213, US

(73) Assignee: NIPPON PAINT CO., LTD.

(21) Appl. No.: 10/096,931

(22) Filed: Mar. 14, 2002

(30) Foreign Application Priority Data
Mar. 15, 2001 (JP) 2001-074572

(51) Int. Cl. C08G 79/02

(52) U.S. Cl. 528/398

(57) ABSTRACT

The present invention is to provide a cationic electrodeposition coating composition which is free from a heavy metal rust inhibitor, such as a lead compound, from the standpoint of the influence upon environment and also is capable of providing a coating film having an excellent corrosion prevention property.

A cationic electrodeposition coating composition

which comprises a water-soluble or water-dispersible phosphonium group-containing compound having a group represented by the following formula (1):

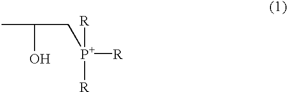

in the formula, R groups may be the same or different and each represents an alkyl group or a hydroxyalkyl group and at least one of R groups is a hydroxyalkyl group.

### FIELD OF THE INVENTION

The present invention relates to a cationic electrodeposition coating composition and more particularly to a cationic electrodeposition coating composition supplemented with a phosphonium group-containing compound as the so-called organic inhibitor expressing a corrosion inhibition effect.

### BACKGROUND OF THE INVENTION

Cationic electrodeposition coatings are not only capable of coating hard-to-reach parts of substrates having complicated shapes but also provide for automated and continuous coating and, as such, find universal application as undercoatings for substrates having large and complicated shapes and calling for high rust inhibition property, such as automotive bodies. Moreover, compared with other coating technologies, the electrocoating technology is economical since the coating efficiency is extremely high, thus being in broad use on a commercial scale.

Cationic electrodeposition coatings in general use in the automotive industry contain an acid-neutralized amine-modified epoxy resin and a blocked isocyanate curing agent, and as rust inhibitors, lead compounds are generally used. Recently, however, from the standpoint of environmental protection, development of cationic electrodeposition coatings not requiring a lead compound has been in progress.

As a cationic electrodeposition coating not requiring a lead compound, Japanese Kokai Publication Hei-05-306327 discloses a composition comprising an oxazolidone ring-containing, amine-modified epoxy resin and a blocked isocyanate curing agent. This technology is intended to impart enhanced rust inhibition property through the oxazolidone ring.

Japanese Kokai Publication 2000-38525 discloses a cationic electrodeposition coating composition which comprises a resin composition having an epoxy resin as a skeleton and containing a sulfonium group, a propargyl group and an unsaturated double bond. This coating composition is also a cationic electrodeposition coating composition not requiring a lead compound and not only adapted to express a high throwing power but also designed to provide a coating film of sufficient thickness even on the reverse side of a substrate having a complicated shape to insure sufficient rust inhibition property on the reverse side as well.

Compared with coating compositions using lead compounds, the corrosion resistance of these cationic electrodeposition coating compositions is not sufficient, however. Therefore, a heavy metal-free rust inhibitor for enhanced corrosion resistance has been demanded.

Meanwhile, Japanese Kokai Publication Hei-06-287776 discloses the use of tetrakis(hydroxymethyl)phosphonium sulfate salt as a corrosion inhibitor for copper. This compound is added to the relevant water system for the purpose of preventing corrosion of copper or copper alloy pipings and the like for use in heat-storage water systems.

However, when this compound is added to a cationic electrodeposition coating, it fails to express the sufficient corrosion prevention property because of its high water solubility and consequent poor compatibility with the resin component constituting the coating film.

### SUMMARY OF THE INVENTION

The present invention has for its object to provide a cationic electrodeposition coating composition which is free from a heavy metal rust inhibitor, such as a lead compound, from the standpoint of the influence upon environment and also is capable of providing a coating film having an excellent corrosion prevention property.

The inventors of the present invention found that a compound containing a phosphonium group having a defined structure such that at least one hydroxyalkyl group is linked, when added to a cationic electrodeposition coating composition, can provide a coating film having excellent corrosion prevention and rust prevention properties even in the absence of a heavy metal rust inhibitor such as a lead compound. The present invention has accordingly be developed.

The present invention, therefore, is directed to a cationic electrodeposition coating composition

which comprises a water-soluble or water-dispersible phosphonium group-containing compound having a group represented by the following formula (1):

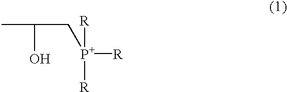

in the formula, R groups may be the same or different and each represents an alkyl group or a hydroxyalkyl group and at least one of R groups is a hydroxyalkyl group.

More over, the present invention is directed to a cationic electrodeposition coating composition

which comprises a water-soluble or water-dispersible phosphonium group-containing compound having an epoxy compound as a basal skeleton and containing a phosphonium group to which at least one hydroxyalkyl group is linked.

The present invention is further directed to a cationic electrodeposition coating composition

which comprises a water-soluble or water-dispersible phosphonium group-containing compound obtained by reacting an epoxy compound with a phosphine compound having at least one hydroxyalkyl group.

### DETAILED DESCRIPTION OF THE INVENTION

The present invention is now described in detail.

The cationic electrodeposiiton coating composition of the invention comprises a water-soluble or water-dispersible phosphonium group-containing compound. The above phosphonium group-containing compound is added as a corrosion/rust inhibitor.

Phosphonium Group-containing Compound

The above phosphonium group-containing compound has a group represented by the above formula (1).

In the above formula (1), R groups may be the same or different and each represents an alkyl group or a hydroxyalkyl group. Said alkyl or hydroxyalkyl group is preferably a group of not more than 6 carbon atoms. If the number of carbon atoms exceeds 6, the hydratability is sacrificed so that a water-soluble or water-dispersible compound may not be obtained.

The alkyl group mentioned above may be straight-chain or branched and includes, for example, methyl, ethyl, n-propyl, i-propyl, n-butyl, i-butyl, t-butyl, and hexyl groups. The hydroxyalkyl group mentioned above includes hydroxymethyl, hydroxyethyl, hydroxypropyl, hydroxybutyl, and hydroxyhexyl groups. The preferred hydroxyalkyl group mentioned above is a hydroxypropyl group.

At least one of said R groups is a hydroxyalkyl group. From hydratability points of view, it is preferable that all the three R groups are hydroxyalkyl groups.

It is particularly preferred, in the present invention, that said phosphonium group is tris(hydroxypropyl)phosphonium group.

The above phosphonium group-containing compound is a water-soluble or water-dispersible compound. If it is not water-soluble or water-dispersible, the compound will be poorly soluble in a cationic electrodeposition coating composition, thus requiring a dispersant resin or the like and detracting the handling property. The preferred is a water-soluble compound.

The above phosphonium group-containing compound has an epoxy compound as a basal skeleton and contains a phosphonium group to which at least one hydroxyalkyl group is linked. The expression “having an epoxy compound as a basal skeleton” as used in this specification means that the compound has a structure such that a functional group, such as the above phosphonium group, is linked, either directly or through an ester bond, an ether bond, or the like, to the terminal generated upon ring-opening of the epoxy group of an epoxy compound. Therefore, it does not matter whether an epoxy group or groups are present.

From the standpoint of compatibility with water, the number average molecular weight of said phosphonium group-containing compound is preferably 300 to 10,000. If it is less than 300, the phosphonium group-containing compound may dissolve into water from the coating film, whereby failing to exhibit the corrosion prevention property. If the molecular weight exceeds 10,000, the phosphonium group-containing compound may not be water-soluble or water-dispersible. The more preferred range is 2,000 to 6,000.

The phosphonium group content of said phosphonium group-containing compound is preferably 0.3 to 3 meq/g. If it is less than 0.3 meq/g, the phosphonium group content is too low to insure the corrosion prevention property. If it exceeds 3 meq/g, hydratability will be too great so that the phosphonium group-containing compound may dissolve into water from the coating film, thus failing to exhibit the corrosion prevention property. The more preferred range is 0.3 to 2 meq/g.

It is preferable that said phosphonium group-containing compound further has an acid anion as the counter anion. The acid anion mentioned above is not particularly restricted but preferably is the anion of an organic acid such as formic acid, acetic acid, lactic acid, propionic acid, butyric acid, dimethylolpropionic acid, dimethylolbutanoic acid, N-acetylglycine, N-acetyl-β-alanine, sulfamic acid or the like.

The above phosphonium group-containing compound may further have an unsaturated bond-containing hydrocarbon group. Furthermore, it may have a blocked isocyanate group. When a compound having an unsaturated bond-containing hydrocarbon group and/or a blocked isocyanate group is added to a cationic electrodeposition coating composition, the crosslinking with the resin and curing agent proceeds to further improve the adhesion and corrosion prevention property of the resulting coating film.

The unsaturated bond-containing hydrocarbon group mentioned above may be straight-chain or branched and the position(s) and number of the above-mentioned unsaturated bonds are not particularly restricted. From the standpoint of compatibility with water, said unsaturated bond-containing hydrocarbon group is preferably a group of 2 to 30 carbon atoms, more preferably a group of 2 to 24 carbon atoms.

The blocked isocyanate group, referred to above, is a group such that while one isocyanate group of a polyisocyanate compound is in the hydrogenated form as —NHCO—, the remaining isocyanate group or groups are blocked with a blocking agent. Such a blocked isocyanate group is linked to the phosphonium compound on the CO— side of the above —NHCO—.

The polyisocyanate compound mentioned above includes, for example, alkylene diisocyanates such as trimethylene diisocyanate, trimethylhexamethylene diisocyanate, tetramethylene diisocyanate, hexamethylene diisocyanate, etc.; cycloalkylene diisocyanates such as bis(isocyanatemethyl)cyclohexane, cyclopentane diisocyanate, cyclohexane diisocyanate, isophorone diisocyanate, etc.; aromatic diisocyanates such as tolylene diisocyanate, phenylene diisocyanate, diphenylmethane diisocyanate, diphenyletherdiisocyanate, etc.; aralkyl diisocyanates such as xylylene diisocyanate, diisocyanatediethylbenzene, etc.; polyisocyanates such as triisocyanates inclusive of triphenylmethane triisocyanate, triisocyanatebenzene, triisocyanatetoluene, etc., tetraisocyanates inclusive of diphenyldimethylmethane tetraisocyanate etc., and tolylene diisocyanate dimer and trimer; and isocyanate-terminated compounds obtained by reacting any of said various polyisocyanate compounds with low-molecular-weight active hydrogen-containing organic compounds such as ethylene glycol, propylene glycol, diethylene glycol, trimethylolpropane, hydrogenated bisphenol A, hexanetriol, glycerol, pentaerythritol, caster oil, triethanolamine, and so forth.

The blocking agent mentioned above includes phenolic blocking agents such as phenol, cresol, xylenol, chlorophenol, ethylphenol, etc.; lactam series blocking agents such as ε-caprolactam, δ-valerolactam, γ-butyrolactam, β-propiolactam, etc.; active methylene series blocking agents such as ethyl acetoacetate, acetylacetone, etc.; alcohol series blocking agents such as methanol, ethanol, propanol, butanol, amyl alcohol, ethylene glycol monomethyl ether, ethylene glycol monoethyl ether, propylene glycol monomethyl ether, benzyl alcohol, methyl glycolate, butyl glycolate, diacetone alcohol, methyl lactate, ethyl lactate, etc.; oxime series blocking agents such as formaldoxime, acetoaldoxime, acetoxime, methyl ethyl ketoxime, diacetyl monoxime, cyclohexane oxime, etc.; mercaptan series blocking agents such as butylmercaptan, hexylmercaptan, t-butylmercaptan, thiophenol, methylthiophenol, ethylthiophenol, etc.; acid amide series blocking agents such as acetamide, benzamide, etc.; imide series blocking agents such as succinimide, maleimide, etc.; and imidazole series blocking agents such as imidazole, 2-ethylimidazole, and so forth.

The phosphonium group-containing compound mentioned above can be obtained by reacting an epoxy compound with a phosphine compound having at least one hydroxyalkyl group.

The staring material epoxy compound mentioned above is not particularly restricted provided that it has at least one epoxy group within a molecule. Thus, as an example of the monofunctional epoxy compound, there can be mentioned nonylphenyl glycidyl ether; as examples of the polyfunctional epoxy compound, there can be mentioned epibisepoxy resins which are reaction products of bicyclic phenol compounds, such as bisphenol A, bisphenol F, bisphenol S, etc., with epichlorohydrin; reaction product obtained by chain extension of these with a diol, such as a bifunctional polyester polyol or polyether polyol, a bisphenol, a dicarboxylic acid, a diamine, or the like; epoxidized polybutadiene; novolac phenol polyepoxy resin; novolac cresol polyepoxy resin; polyglycidyl acrylate; polyglycidyl ethers of aliphatic polyols or polyether polyols, such as triethylene glycol diglycidyl ether, tetraethylene glycol diglycidyl ether, polyethylene glycol diglycidyl ether, etc.; and polyglycidyl esters of polybasic carboxylic acids. Among these, polyfunctional epoxy compounds having 2 or more epoxy groups are preferred. The more preferred are epibisepoxy resins, novolac phenol type polyepoxy resins, novolac cresol polyepoxy resins, and polyglycidyl ethers of aliphatic polyols or polyether polyols.

The number average molecular weight of said epoxy compound is preferably 240 to tens of thousands. If it is less than 240, the resulting phosphonium group-containing compound becomes too high in hydratability to be retained in the coating film, thus failing to provide for corrosion prevention property. If the molecular weight is higher than tens of thousands, the resulting phosphonium group-containing compound may possibly be hardly water-soluble or water-dispersible. The more preferred molecular weight range is 300 to 10,000.

The preferred epoxy compound has an epoxy equivalent of 50 to 1500. If it exceeds 1500, the phosphonium group content of the resulting phosphonium group-containing compound will be too small to insure the corrosion prevention property. If the epoxy equivalent is less than 50, the resulting phosphonium group-containing compound will be so high in hydratability that the phosphonium group-containing compound tends to dissolve into water from the coating film, thus failing to exhibit the corrosion prevention property. The preferred epoxy equivalent is 100 to 1,000.

As said epoxy compound, modification products thereof may be used.

The method for modification of the above epoxy compound includes the method comprising the ring-opening addition of an alcohol and/or a carboxylic acid to some of the epoxy groups, for instance.

Such a modification may be made for the purpose of consuming epoxy groups to adjust the phosphonium group content of the objective phosphonium group-containing compound or for the purpose of introducing a functional group or adjusting physical properties by modification, or for both purposes, and the method of modification can be properly selected according to the application purpose or the amount of use.

The above-mentioned alcohol or carboxylic acid is not particularly restricted when the modification is made for the purpose of adjusting the phosphonium group content of the phosphonium group-containing compound. However, a compound that does not finally affect the resulting phosphonium salt should be selected. When said modification is made for the purpose of introducing a functional group or adjusting physical properties, said alcohol and/or carboxylic acid includes a compound having a saturated hydrocarbon group of not less than 6 carbon atoms; and a compound containing unsaturated bond such as an unsaturated triple bond or an unsaturated double bond.

The preferred is the case in which the modification is made with a compound having an unsaturated bond-containing hydrocarbon group, whereby a phosphonium group-containing compound having said unsaturated bond-containing hydrocarbon group can be obtained.

The unsaturated bond-containing alcohol is not particularly restricted but includes, for example, unsaturated triple bond-containing alcohols, such as propargyl alcohol; and unsaturated double bond-containing alcohols, such as allyl alcohol, 2-hydroxyethyl acrylate, 2-hydroxyethyl methacrylate, hydroxypropyl acrylate, hydroxypropyl methacrylate, hydroxybutyl acrylate, hydroxybutyl methacrylate, methacryl alcohol, and so forth.

The unsaturated bond-containing carboxylic acid is not particularly restricted but includes, for example, unsaturated triple bond-containing carboxylic acids, such as propargylic acid; acrylic acid, methacrylic acid, ethacrylic acid, crotonic acid, maleic acid, phthalic acid, itaconic acid; half esters such as ethyl maleate, ethyl fumarate, ethyl itaconate, mono(meth)acryloyloxyethyl succinate, mono(meth)acryloyloxyethyl phthalate, etc.; synthetic unsaturated fatty acids such as oleic acid, linoleic acid, ricinolic acid, etc.; and naturally-occurring unsaturated fatty acids such as linseed oil, soybean oil and so forth.

When said modification is made with a compound having an unsaturated triple bond-containing hydrocarbon group, propargyl alcohol is preferably used in view of availability and ease of reaction.

On the other hand, as the alcohol and/or carboxylic acid having a saturated hydrocarbon group of not less than 6 carbon atoms, saturated hydrocarbon alcohols such as 2-ethylhexanol, nonylphenol, ethylene glycol mono-2-ethylhexyl ether, propylene glycol mono-2-ethylhexyl ether, etc.; and saturated hydrocarbon carboxylic acids such as stearic acid, octylic acid, etc. can be used for the purpose of adjusting molecular weight and/or of improving thermal flow characteristics.

In the case where said epoxy compound has a hydroxyl group generated upon ring-opening of an epoxy group, urethane modification involving said hydroxyl group with a half-blocked isocyanate is also feasible. In this case, a phosphonium group-containing compound having said blocked isocyanate group can be obtained. In this case, the blocked isocyanate group is linked to said hydroxyl group from which the hydrogen atom has been removed.

The half-blocked isocyanate mentioned above is said polyisocyanate compound whose isocyanate group or groups except one group has been blocked with a blocking agent.

The reaction conditions for said modification are usually at room temperature or 80 to 140° C. and for several hours. Where necessary, the known substances necessary to proceed the reaction, such as a catalyst and a solvent, may be employed. The end-point of reaction can be confirmed by determining the epoxy equivalent, and the introduced functional group can be confirmed by analyzing the nonvolatile matter or by instrumental analysis of the resulting resin composition.

The phosphine compound to be reacted with said epoxy compound has at least one hydroxyalkyl group.

The phosphine compound mentioned above can be obtained by reacting phosphine (PH₃) with an alcohol, such as allyl alcohol. From availability points of view, a commercial product such as Hishicaulin P-500 (product of Nippon Chemical Industrial Co., Ltd.; tris(hydroxypropyl)phosphine) can also be used.

The phosphine compound mentioned above includes, for example, tris(hydroxypropyl)phosphine, tris(hydroxyethyl)phosphine, tris(hydroxymethyl)phosphine, and dihydroxybutyl(butyl)phosphine, etc.

The above-mentioned phosphonium group-containing compound is preferably a compound having a tris(hydroxypropyl)phosphonium group as the phosphonium group and, therefore, tris(hydroxypropyl)phosphine is used as the above phosphine compound, in this case.

The above phosphonium group-containing compound can be obtained by reacting said epoxy compound with said phosphine compound. This reaction is generally carried out in the presence of an acid compound. This acid compound becomes the counter aninon for the above phosphonium group-containing compound after the reaction and, therefore, the organic acid mentioned above is used as the above acid compound.

More particularly, the above reaction can be carried out by adding a mixed solution of phosphine/acid/water to the epoxy compound and heating the mixture. In the case where said epoxy compound is a solid, it is preferably melted by heating in advance.

Regarding the ratio of reactants in the above reaction, with the epoxy equivalent of the epoxy compound being taken as 1, the ratio of each of the phosphine and acid compound is 0.8 to 1.2 equivalents, preferably 0.9 to 1.1 equivalents, and that of water is 1 to 20 equivalents.

Regarding the mixing ratio between said phosphine and said acid compound, the molar ratio of the acid compound relative to the phosphine is preferably about 0.8 to 1.2, in general.

The reaction solvent mentioned above is not particularly restricted but, for example, an ether solvent which is freely miscible with water is preferred.

Since the above reaction is considered to proceed more or less quantitatively, the conversion rate to phosphonium can be adjusted by controlling the amount of phosphine relative to the epoxy group. It is supposed that the epoxy group which has not been converted to phosphonium exists as cleaved open by water.

The conversion rate from epoxy group to phosphonium can be selected according to the application purpose and the amount of use of the resulting phosphonium group-containing compound but is preferably not less than 30%, more preferably not less than 50%.

The reaction temperature is not particularly restricted provided that it is a temperature not causing decomposition of the starting materials and the resulting phosphonium group-containing compound. For example, it may be room temperature through 90° C. and is preferably about 75° C.

The above reaction can be carried out until it is confirmed by measuring the acid value that the value has steadied at a level not higher than 5. Thereafter, the reaction mixture is cooled to give the phosphonium group-containing compound. This is generally used as diluted with water to an appropriate concentration of about 50%.

The phosphonium group-containing compound thus obtained can be confirmed by molecular weight determination by GPC using a highly polar solvent such as N,N-dimethylformamide and the phosphonium content can be determined by potentiometric titration.

As mentioned above, said phosphonium group-containing compound can be obtained by reacting the epoxy compound with the phosphine compound having at least one hydroxyalkyl group and has been confirmed to have the phosphonium group represented by said formula (1).

Cationic Electrodeposition Coating Composition

The cationic electrodeposition coating composition of the present invention contains said phosphonium group-containing compound. In the cationic electrodeposition coating composition, said phosphonium group-containing compound functions as a so-called organic inhibitor expressing a corrosion inhibition effect.

Preferably the above phosphonium group-containing compound is added at a level of 0.5 to 10 weight % relative to the resin solids of the cationic electrodeposition coating composition. If the level is below 0.5 weight %, the corrosion prevention property of the resulting coating film may be poor, in some cases. If the level exceeds 10 weight %, no further effect may be expected but rather curability will be sacrificed and the physical properties of the coating film tend to be adversely affected. The more preferred level is 2 to 7 weight %.

The cationic electrodeposition coating composition mentioned above is not particularly restricted but with any of the cationic electrodeposition coatings heretofore in use, electrodeposited coating films with satisfactory corrosion prevention property can be obtained by adding the above phosphonium group-containing compound. Preferably, the composition comprising an amine-modified epoxy resin as the basal resin and a blocked isocyanate curing agent (hereinafter referred to as cationic electrodeposition coating composition [1]) or a composition comprising an unsaturated hydrocarbon group-containing sulfide-modified epoxy resin (hereinafter referred to as cationic electrodeposition coating composition [2]) is used since the corrosion prevention property of the resulting coating films can further be improved.

Cationic Electrodeposition Coating Composition [1]

Said cationic electrodeposition coating composition [1] comprises an amine-modified epoxy resin as the basal resin and a blocked isocyanate curing agent.

The above amine-modified epoxy resin can be produced by causing the epoxy ring of a starting material epoxy resin to undergo ring-opening with an amine such as a primary amine, secondary amine or tertiary amine acid salt.

The starting material epoxy resin mentioned above includes the compounds specifically mentioned hereinbefore referring to the polyfunctional epoxy compound.

In the above cationic electrodeposition coating composition [1], said epoxy resin is preferably the oxazolidone ring-containing epoxy resin described in Japanese Kokai Publication Hei-05-306327. By using said oxazolidone ring-containing epoxy resin, further improvements can be realized in throwing power and corrosion preventing property of the resulting coating film.

The above oxazolidone ring-containing epoxy resin can be obtained by reacting the epoxy compound specifically mentioned above with a diisocyanate compound or with a bisurethane compound which is obtained by blocking NCO group of a diisocyanate compound with a lower monoalcohol such as methanol or ethanol.

As the above starting material epoxy resin, there can be also used, as mentioned above, a modification product obtained by ring-opening addition of an alcohol and/or a carboxylic acid to some of the epoxy groups, or a product obtained by chain extension with a bifunctional polyol or a dibasic acid.

The amine compound which can be used for causing the epoxy ring of said epoxy compound to undergo ring-opening and introducing an amino group includes primary, secondary or tertiary amines such as butylamine, octylamine, diethylamine, dibutylamine, methylbutylamine, monoethanolamine, diethanolmaine, N-methylethanolamine, triethylamine acid salts, N,N-dimethylethanolamine acid salts, and so forth. Furthermore, there may also be used ketimine-blocked primary amino group-containing secondary amines such as aminoethylethanolamine methyl isobutyl ketimine and so forth.

The amine mentioned above needs to be reacted at a proportion of not less than 80% relative to the epoxy ring.

The number average molecular weight of said amine-modified epoxy resin is preferably 600 to 4,000. If it is less than 600, the physical properties, such as solvent resistance and corrosion resistance, of the resulting coating film tend to be unsatisfactory. If the molecular weight exceeds 4,000, not only control of the viscosity of the resin solution becomes difficult to make the synthesis difficult but handling during such procedures as emulsification and dispersion of the resulting resin tends to be difficult. Furthermore, because of high viscosity, the resin is so poor in flowability in the heat curing stage that the appearance of the coating film tends to be seriously impaired.

The amino value of said amine-modified epoxy resin is preferably 30 to 150, more preferably 45 to 120. If it is less than 30, a stable emulsion may hardly be obtained. If it exceeds 150, workability upon electrodeposition coating such as Coulomb efficiency and re-dissolution property tend to be adversely affected.

The blocked isocyanate curing agent mentioned above can be obtained by reacting a polyisocyanate compound having two or more isocyanate groups with a blocking agent which can add itself to an isocyanate group and, although stable at room temperature, is capable of regenerating a free isocyanate group when heated at a temperature not lower than its dissociation temperature, and those curing agents which are conventionally used for cationic electrodeposition coatings can be employed. As specific examples of said polyisocyanate compound and blocking agent, those specifically mentioned hereinbefore can be mentioned.

The weight ratio of said amine-modified epoxy resin and blocked isocyanate curing agent on a solid basis is preferably 50/50 to 90/10, more preferably 60/40 to 80/20. Deviation from the above range tends to cause a trouble in curability.

The above cationic electrodeposition coating composition [1] further contains a neutralizing acid for dispersing the above-mentioned components in water. The neutralizing acid, to mention the one for use in the reaction with said amine, includes not only the organic acids specifically mentioned hereinabove referring to the acid compound but also inorganic acids such as boric acid, hydrochloric acid, sulfuric acid, phosphoric acid, and so forth. The amount of said neutralizing acid varies with the amount of the amino group in said amine-modified epoxy resin and needs only to be such amount that the amino groups may be dispersed in water.

The above cationic electrodeposition coating composition [1] may further contain a pigment and a pigment dispersant resin. The pigment mentioned above is not particularly restricted provided that it is a pigment conventionally used, thus including, for example, color pigments such as titanium dioxide, carbon black, red iron oxide, etc. and extender pigments such as kaolin, talc, aluminum silicate, calcium carbonate, mica, clay, silica, and so on.

In the cationic electrodeposition coating composition [1], said phosphonium group-containing compound may be used in combination with another rust-preventive pigment. The rust-preventive pigment mentioned above includes zinc phosphate, iron phosphate, aluminum phosphate, calcium phosphate, zinc phosphite, zinc cyanide, zinc oxide, aluminum tripolyphosphate, zinc molybdate, aluminum molybdate, and calcium molybdate-aluminum phosphomolybdate.

As the pigment dispersant resin mentioned above, cationic or nonionic low-molecular-weight surfactants and modified epoxy resins containing quaternary ammonium group and/or tertiary sulfonium group are generally used.

The above-mentioned pigment dispersant resin and pigment are admixed in a predetermined amount and dispersed with a conventional dispersing machine, such as a ball mill or a sand grind mill, until the pigment particles in the mixture have become a predetermined uniform particle diameter. This pigment dispersion paste can be used at the amount of 0 to 50 weight % on a solid basis of the pigment in the cationic electrodeposition coating composition.

Furthermore, said cationic electrodeposition coating composition [1] may additionally contain the conventional additives for a coating, such as a surfactant, an antioxidant, a UV absorber, a curing accelerator, and so forth.

The above cationic electrodeposition coating composition [1] can be obtained by admixing the amine-modified epoxy resin, blocked isocyanate curing agent, phosphonium group-containing compound, and, where necessary, pigment dispersion paste and additives for a coating. Since said phosphonium group-containing compound is water-soluble, this admixing is preferably effected by the following procedure. First, the amine-modified epoxy resin is mixed with the blocked isocyanate curing agent and, then, the neutralizing acid is added. To this mixture is added the phosphonium group-containing compound, and the whole mixture is dispersed in an aqueous medium, which may be water alone or a mixture of water with a hydrophilic organic solvent, followed by mixing with the pigment dispersion paste, where necessary, to give the cationic electrodeposition coating composition [1]. The additives may be added to the system in any arbitrary stage or stages.

The above cationic electrodeposition coating composition [1] is cationically electrocoated on a substrate. Cationic electrodeposition coating can be carried out according to the per se known method. Generally, the method comprises diluting the cationic electrodeposition coating composition with deionized water to a solid matter concentration of 5 to 40 weight %, preferably 15 to 25 weight %, adjusting the pH within the range of 5.5 to 8.5 to prepare an electrodeposition bath, adjusting the temperature of the bath to 20° C. to 35° C., and carrying out the electrodeposition coating using a coating voltage of 100 to 450 V.

The recommendable film thickness on the above electrodeposition coating is within a range of 5 to 40 μm, preferably 10 to 30 μm, on a dry film basis, and the above electrodeposition coating conditions are preferably set so as to insure the above film thickness. Baking of the coating film is generally carried out at 100 to 220° C., preferably 140 to 200° C., for a time period ranging from 10 to 30 minutes.

Cationic Electrodeposition Coating Composition [2]

Said cationic electrodeposition coating composition [2] comprises an unsaturated hydrocarbon group-containing sulfide-modified epoxy resin as the basal resin.

The above sulfide-modified epoxy resin can be obtained by reacting an epoxy resin with a sulfide/acid mixture and has the epoxy resin as a skeleton, with sulfonium groups being linked via epoxy rings cleaved open.

The above epoxy resin includes the compounds specifically mentioned above referring to the polyfunctional epoxy compound. In view of the fact that the polyfunctionalization for enhanced curability is feasible, novolac epoxy resins such as novolac phenol epoxy resin and novolac cresol epoxy resin are preferred.

The number average molecular weight of the starting material epoxy resin is preferably 400 to 15,000, more preferably 650 to 12,000.

The number average molecular weight of the above sulfide-modified epoxy resin is preferably 500 to 20,000. If it is less than 500, cationic electrodeposition coating efficiency will be poor. If it exceeds 20,000, a satisfactory coat will not be formed on the substrate surface. More preferred number average molecular weight can be selected according to the resin skeleton and, in the case of a novolac phenol epoxy resin or a novolac cresol epoxy resin, the more preferred molecular weight is 700 to 5,000.

In the above cationic electrodeposition coating composition [2], the above resin having the epoxy resin as a skeleton has a sulfonium group and an unsaturated hydrocarbon group introduced via ring-opened epoxy groups of the above epoxy resin forming s skeleton. The unsaturated hydrocarbon group mentioned above is preferably a propargyl group, more preferably the one disclosed in Japanese Kokai Publication 2000-38525, which has an unsaturated double bond in addition to a propargyl group from curability points of view. The unsaturated double bond mentioned above is a carbon-carbon double bond.

Referring to said unsaturated hydrocarbon group-containing sulfide-modified epoxy resin, the resin having the epoxy resin as a skeleton may contain both a sulfonium group and an unsaturated hydrocarbon group invariably in each molecule but this is not necessarily essential and the resin may for example be a mixture of resin molecules containing a sulfonium group only in each molecule and resin molecules containing both a sulfonium group and an unsaturated hydrocarbon group in each molecule. Similar to this, as for the above-mentioned case in which the resin contains not only a propargyl group but also an unsaturated double bond, the resin may contain all of three kinds of a sulfonium group, a propargyl group, and an unsaturated double bond in each molecule. However, this is not necessarily essential and a resin molecule may contain only one or two of a sulfonyl group, a propargyl group, and an unsaturated double bond in each molecule.

The sulfonium group is a hydration functional group in said cationic electrodeposition coating composition [2]. It is considered that when a voltage or current over a certain level is applied in the course of electrodeposition coating, the sulfonium group is electrolytically reduced on the electrode to lose its ionic group and is irreversibly rendered non-conductive. It is suspected for this reason that the above cationic electrodeposition coating composition [2] may express a high degree of throwing power.

Furthermore, in this course of electrodepostion coating, the electrode reaction is induced and it is considered that the resulting hydroxide ion is retained by the sulfonium group to give an electrolytically generated base in the electrodeposited coat. By generation of this electrolytically generated base, the propargyl group which shows low reactivity upon heating occurring in the electrodeposited coat is converted to an allene linkage which shows high reactivity upon heating.

The sulfonium group content is preferably 5 to 400 mmol relative to 100 g resin solids of the cationic electrodeposition coating composition [2]. If it is less than 5 mmol/100 g, neither sufficient throwing power nor sufficient curability may be expressed and, moreover, hydratability and bath stability will be adversely affected. If the sulfonium group content exceeds 400 mmol/100 g, deposition of the coat on the substrate surface will be adversely affected. More preferred content can be selected according to the resin skeleton and in the case of a novolac phenol epoxy resin or a novolac cresol epoxy resin, for example, the content is preferably 5 to 250 mmol, more preferably 10 to 150 mmol relative to 100 g resin solids.

It is considered that as the propargyl group mentioned above is converted to the allene bond as mentioned above, it provides for enhanced reactivity and constitutes a curing system. Moreover, although the reason remains to be known, coexistence with the sulfonium group can contribute to a further improvement in the throwing power of the resin composition.

In the case where the cationic electrodeposition coating composition [2] contains said propargyl group, its content is preferably 10 to 485 mmol relative to 100 g resin solids. If it is less than 10 mmol/100 g, neither sufficient throwing power nor sufficient curability can be expressed. If it exceeds 485 mmol/100 g, the hydration stability of the resulting cationic electrodeposition coating tends to be adversely affected. More preferred content can be selected according to the resin skeleton and in the case of a novolac phenol epoxy resin or a novolac cresol epoxy resin, for example, the preferred content is 20 to 375 mmol relative to 100 g resin solids.

In the case where said unsaturated hydrocarbon group-containing sulfide-modified epoxy resin has an unsaturated double bond in addition to said propargyl group, the high reactivity of this unsaturated double bond contributes to a further improvement in curability.

The above unsaturated double bond content is preferably 10 to 485 mmol relative to 100 g resin solids of the cationic electrodeposition coating composition [2]. If it is less than 10 mmol/100 g, no sufficient curability will be expressed. If it exceeds 485 mmol/100 g, the hydration stability of the resulting cationic electrodeposition coating tends to be adversely affected. More preferred content can be selected according to the resin skeleton and in the case of a novolac phenol epoxy resin or a novolac cresol epoxy resin, for example, the preferred content is 20 to 375 mmol relative to 100 g solids of the resin composition.

Referring, further, to the above cationic electrodeposition coating composition [2], in the case where the epoxy resin additionally containing an unsaturated double bond is used, the unsaturated double bond content is expressed in the equivalent amount of the epoxy group content into which the unsaturated double bond has been introduced. Stated differently, for example, even when a molecule containing a plurality of unsaturated double bonds within a molecule, such as a long-chain unsaturated fatty acid, is introduced into an epoxy group, the unsaturated double bond content is expressed in the content of the epoxy group into which said molecule containing a plurality of unsaturated double bonds has been introduced. This is because even when a molecule containing a plurality of unsaturated double bonds within a molecule is introduced into one epoxy group, it is considered that only one of the unsaturated double bonds practically takes part in the curing reaction.

The total content of said sulfonium group and unsaturated hydrocarbon group is preferably not more than 500 mmol relative to 100 g resin solids. If it exceeds 500 mmol, the resin may not actually be obtained or the desired performance may not be attained. More preferred content can be selected according to the resin skeleton and in the case of a novolac phenol epoxy resin or a novolac cresol epoxy resin, for example, said total content is preferably not more than 400 mmol.

Furthermore, the total content of the propargyl group and unsaturated double bond is preferably within the range of 80 to 450 mmol relative to 100 g of resin solids. If it is less than 80 mmol, curability tends to be insufficient. If it exceeds 450 mmol, the sulfonium group content will be decreased and the throwing power tends to be insufficient. More preferred content can be selected according to the resin skeleton and in the case of a novolac phenol epoxy resin or a novolac cresol epoxy resin, for example, the more preferred range is 100 to 395 mmol.

The unsaturated hydrocarbon group-containing sulfide-modified epoxy resin mentioned above may have a curing catalyst introduced. For example, when a curing catalyst capable of forming an acetylide with a propargyl group is employed, some of the propargyl groups are converted to acetylides to thereby introduce the curing catalyst into the resin.

Production of said unsaturated hydrocarbon group-containing sulfide-modified epoxy resin can be carried out as follows. Thus, an epoxy resin having at least two epoxy groups in each molecule is first reacted with an unsaturated hydrocarbon group-containing compound and, thereafter, an acid/sulfide mixture is caused to react with the remaining epoxy groups to introduce sulfonium groups. By carrying out the introduction of sulfonium groups later, the decomposition of sulfonium groups upon heating can be prevented.

As said unsaturated hydrocarbon group-containing compound, the unsaturated bond-containing alcohol and/or carboxylic acid used hereinabove for modification of the epoxy compound can be employed. The kinds and amount of said unsaturated hydrocarbon group-containing compound can be selected according to the kind and amount of the unsaturated hydrocarbon group to be introduced.

The above reaction can be carried out by the same procedure as described hereinabove for the modification reaction. Moreover, when both a propargyl group and an unsaturated double bond are contained in an unsaturated hydrocarbon group, a propargyl group-containing compound and an unsaturated double bond-containing compound are used in the reaction and it does not matter which of these compounds is first reacted. Optionally, both compounds may be reacted simultaneously.

To the remaining epoxy group of thus-obtained unsaturated hydrocarbon group-containing epoxy resin composition, a sulfonium group is introduced. This introduction of the sulfonium group can be effected by a method which comprises causing a sulfide/acid mixture to react with the epoxy group for introduction of the sulfide and conversion thereof to sulfonium or a method which comprises introducing a sulfide, then carrying out a reaction for converting the introduced sulfide to sulfonium with an acid or an alkyl halide and, where necessary carrying out an anion-exchange. In view of the availability of reactants, the method using a sulfide/acid mixture is preferred.

The sulfide mentioned above is not particularly restricted but includes, for example, aliphatic sulfides, aliphatic-aromatic mixed sulfides, aralkyl sulfides, and cyclic sulfides, and as substituents linked to these sulfides, groups of 2 to 8 carbon atoms are preferred. As specific examples, there can be mentioned diethyl sulfide, dipropyl sulfide, dibutyl sulfide, dihexyl sulfide, diphenyl sulfide, ethylphenyl sulfide, tetramethylene sulfide, pentamethylene sulfide, thiodiethanol, thiodipropanol, thiodibutanol, 1-(2-hydroxyethylthio)-2-propanol, 1-(2-hydroxyethylthio)-2-butanol, 1-(2-hydroxyethylthio)-3-butoxy-1-propanol, and so forth.

The acid mentioned above includes the organic acids and inorganic acids mentioned hereinbefore.

The ratio of reactants in the above reaction, mixing ratio between the sulfide and acid, reaction conditions, and method for confirmation of introduction of sulfonium groups into the resin composition may be the same as those described above for the reaction of said phosphine/acid compound.

The above cationic electrodeposiiton coating composition [2] does not necessarily need the use of a curing agent because the resin itself has curability. However, a curing agent may be used for attaining a further improvement in curability. Such a curing agent includes, for example, compounds having a plurality of at least one group among a propargyl group and unsaturated double bond, for example compounds obtained by addition reaction of a polyepoxide such as novolak phenol, pentaerythritol tetraglycidyl ether or the like to a propargyl group-containing compound such as propargyl alcohol or an unsaturated double bond-containing compound such as acrylic acid.

For the above cationic electrodepositon coating composition [2], a curing catalyst can be used to proceed a curing reaction between unsaturated bonds. Such a curing catalyst is not particularly restricted but includes, for example, compounds resulting from the combination of a transition metal, such as nickel, cobalt, copper, manganese, palladium, rhodium or the like, with a ligand, such as cyclopentadiene, acetylacetone, or the like, or a carboxylic acid such as acetic acid or naphthenic acid. Among these, the preferred are acetylacetonato-copper complex and copper acetate. The formulating amount of said curing catalyst is preferably 0.1 to 20 mmol relative to 100 g resin solids of the cationic electrodeposition coating composition [2].

The cationic electrodeposition coating composition [2] may be further formulated with an amine. Addition of the above amine results in an increased conversion rate of sulfonium group to sulfide due to electrolytic reduction in the course of electrodeposition. The amine mentioned above is not particularly restricted but includes, for example, amine compounds such as primary through tertiary monofunctional and polyfunctional aliphatic amines, alicyclic amines, aromatic amines, and so forth. Among these, water-soluble or water-dispersible amines are preferred. Thus, there can be mentioned, for example, alkylamines of 2 to 8 carbon atoms, such as monomethylamine, dimethylamine, trimethylamine, triethylamine, propylamine, diisopropylamine, tributylamine, etc.; monoethanolamine, dimethanolamine, methylethanolamine, dimethylethanolamine, cyclohexylamine, morpholine, N-methylmorpholine, pyridine, pyrazine, piperidine, imidazoline, imidazole, and so forth. These may be used each independently or in a combination of two or more kinds. Among these, hydroxylamines such as monoethanolamine, diethanolmaine, dimethylethanolamine, etc. are preferred from the standpoint of excellent aqueous dispersion stability.

The level of addition of said amine is preferably 0.3 to 25 meq relative to 100 g resin solids of the cationic electrodeposition coating composition [2]. If it is below 0.3 meq/100 g, sufficient effect on throwing power will not be expressed. If the level exceeds 25 meq/100 g, the effect proportional to the level of addition will not be obtained, thus causing an economic disadvantage. The more preferred range is 1 to 15 meq/100 g.

Where necessary, said cationic electrodeposition coating composition [2] may contain other components. As such other components, those specifically mentioned hereinabove referring to the cationic electrodeposition coating composition [1] can be employed.

With regard to the pigment dispersant resin, among said other components, the resins specifically mentioned hereinabove referring to the cationic electrodeposition coating composition [1] can be used but it is preferable to use a pigment dispersant resin containing a sulfonium group and an unsaturated bond within a resin. Such a pigment dispersant resin containing a sulfonium group and an unsaturated bond can be obtained, for example by a method which comprises reacting a bisphenol epoxy resin with a half-blocked isocyanate and reacting the resulting hydrophobic epoxy resin with a sulfide compound or a method which comprises reacting said resin with a sulfide compound in the presence of a monobasic acid and a hydroxyl group-containing dibasic acid.

The above cationic electrodepositon coating composition [2] can be prepared by admixing said components. Moreover, the above cationic electrodeposition coating composition [2] can be electrocoated and baked under the same conditions as specifically mentioned hereinabove referring to the cationic electrodeposition coating composition [1].

The substrate for electrodeposition coating with the cationic electrodeposition coating composition of the invention is not particularly restricted provided that it is electrically conductive, thus including metals such as iron, zinc, aluminum, etc.; alloys of these metals; and shaped articles of metal or alloy, such as automotive bodies and parts thereof.

The cationic electrodeposited coating film formed from said cationic electrodeposition coating composition can be formed, if necessary, with an intermediate coating film thereon followed by formation of a top coating film. For the formation of said intermediate coating film and top coating film, the coatings and coating conditions used for coating of automotive and other shell panels can be employed.

As described above, the composition of the present invention comprises a water-soluble or water-dispersible phosphonium group-containing compound. The mechanism of improvement in the corrosion prevention property of the above metal substrate which is obtained in the case that said phosphonium group-containing compound is added remains to be unknown yet but it is considered that a certain bond is formed or a certain interaction takes place between the metal and the phosphonium group to improve the adhesion to the substrate and, hence, improve the durability and corrosion prevention property. Furthermore, when the cationic electrodeposition coating composition [1], which contains an amine-modified epoxy resin and a blocked isocyanate curing agent, is used as the cationic electrodeposition coating composition, there can be obtained an electrodeposited coating film representing a further improvement in the corrosion prevention property. Moreover, when the cationic electrodeposition coating composition [2], which contains an unsaturated hydrocarbon group-containing sulfide-modified epoxy resin, is used, there can be obtained a coating film having the sufficient corrosion prevention property even on the reverse side of the substrate owing to its superior throwing power, as well as corrosion prevention property.

The cationic electrodeposition coating composition according to the present invention comprises a water-soluble or water-dispersible phosphonium group-containing compound and, therefore, can provide an electrodeposited coating film having an excellent corrosion prevention property. Since the above-mentioned phosphonium group-containing compound contains no heavy metal, it is environmental friendly and highly compatible with the resin component constituting the coating film.

### EXAMPLES

The following examples illustrate the present invention in further detail without defining the scope of the invention.

### Production Example 1

Production of a Phosphonium Group-Containing Compound (Based on a Monofunctional Epoxy Compound)

A reaction vessel was charged with 325.0 g of NH-300P (epoxy equivalent 325; nonylphenyl glycidyl ether; product of Sanyo Chemical Ind., Ltd.) and heated to 100° C. Then, an aqueous solution prepared from 208.2 g of tris(3-hydroxypropyl)phosphine (Hishichaulin P-500; product of Nippon Chemical Industrial Co., Ltd.), 60.0 g of acetic acid, and 144.0 g of deionized water was gradually added and the resulting mixture was maintained at 75° C.

After confirming that the acid value had steadied at not more than 5, 251.5 g of deionized water was added, followed by cooling. The product was then withdrawn (nonvolatile matter (hereinafter, sometimes referred as NV)=60%, number average molecular weight 590; phosphonium group content 1.7 meq/g; conversion rate from epoxy group to phosphonium=100%). The conversion rate from epoxy group to phosphonium was determined by potentiometric titration with 1/10N hydrochloric acid.

### Production Example 2

Production of a Phosphonium Group-containing Compound (Based on a Novolac Epoxy Compound)

A reaction vessel was charged with 2426.4 g of YDCN-703 (epoxy equivalent 202.2, cresol novolak epoxy resin; 12 nuclei; product of Tohto Chemical), and 1257.0 g of ethylene glycol monobutyl ether. The mixture was heated at 130° C. in a nitrogen atmosphere to dissolve uniformly.

Then, after cooling to 100° C., an aqueous solution prepared from 1619.1 g of Hishicaulin P-500, 432.0 g of acetic acid, and 1728 g of deionized water was gradually added and, then, maintained at 75° C. with cooling. The reaction was continued until an acid value of not more than 5 had been attained.

After confirming that the acid value had steadied at not more than 5, 1492.5 g of deionized water was added, followed by cooling. (NV=50%, number average molecular weight 4500, phosphonium group content 1.6 meq/g; conversion rate from epoxy group to phosphonium=60%).

### Production Example 3

Production of a Phosphonium Group-Containing Compound (Based on a Novolac Epoxy Resin (Containing an Unsaturated Group))

A reaction vessel was charged with 2426.4 g of YDCN-703 (epoxy equivalent 202.2; cresol novolak epoxy resin; 12 nuclei; product of Tohoto Chemical) and 1682.4 g of enzymatically treated linseed oil fatty acid and the mixture was heated to 120° C. After dissolving uniformly, 7.28 g of ethyltriphenylphosphonium iodide was added. After confirming that an acid value of not more than 1 had been attained, 2426.4 g of ethylene glycol monobutyl ether was added.

Then, an aqueous solution prepared from 1349.3 g of Hishicaulin P-500, 360.0 g of acetic acid, and 3384.4 g of deionized water was gradually added and the mixture was maintained at 75° C.

After confirming that the acid value had steadied at not more than 5, the reaction mixture was cooled and the product was withdrawn. (NV=50%, number average molecular weight 5800, phosphonium group content 1.0 meq/g; conversion rate from epoxy group to phosphonium=50%).

### Production Example 4

Production of a Phosphonium-Group Containing Compound (Based on Epibis Type Epoxy Resin (Containing no Unsaturated Group))

An reaction vessel was charged with 970.0 g of Epikote 1001 (epoxy equivalent 485; bisphenol A epoxy resin; product of Yuka-shell Epoxy Co.) and 265.0 g of PCPO 200 (polycaprolactonediol; product of Union Carbide). The mixture was heated at 130° C. in a nitrogen atomosphere and 0.46 g of dimethylbenzylamine was added. This reaction mixture was further heated to 150° C. and maintained at this temperature for 3 hours. Thereafter, 607.6 g of ethylene glycol monobutyl ether was added, followed by cooling to 110° C.

Thereafter, an aqueous solution prepared from 124.9 g of Hishicaulin P-500, 36.0 g of acetic acid, and 144.0 g of deionized water was gradually added and the whole mixture was maintained at 75° C.

After confirming that the acid value had steadied at not more than 5, 644.3 g of deionized water was added followed by cooling. The product was then withdrawn. (NV=50%, number average molecular weight 2800, phosphonium group content 0.4 meq/g; conversion rate from epoxy group to phosphonium=60%).

### Production Example 5

Preparation of a Blocked Isocyanate

A reaction vessel equipped with a stirrer, condenser, nitrogen gas inlet pipe, thermometer, and dropping funnel was charged with 92 g of 2,4-/2,6-tolylene diisocyanate (weight ratio=8/2), 95 g of methyl isobutyl ketone (hereinafter, referred as MIBK in short), and 0.5 g of dibutyltin dilaurate, and while stirring, 21 g of methanol was further added dropwise. The reaction was initiated at room temperature but the evolution of heat elevated the temperature to 60° C.

The reaction was then continued for 30 minutes, after which 57 g of ethylene glycol mono-2-ethylhexyl ether was added dropwise from the dropping funnel. Thereafter, 42 g of bisphenol A-propylene oxide (5 mole) adduct was added.

The reaction was mostly carried out within the range of 60 to 65° C. and under IR spectrometric monitoring, the reaction was continued until the absorption due to the isocyanate group had disappeared.

### Production Example 6

Preparation of a Basal Resin

To the blocked isocyanate obtained in Production Example 5 was added 365 g of an epoxy resin having an epoxy equivalent of 188 as synthesized from bisphenol A and epichlorohydrin, and the temperature was increased to 125° C. Then, 1.0 g of benzyldimethylamine was added and the reaction was carried out at 130° C. until the epoxy equivalent had reached 410. Then, 87 g of bisphenol A was added to the above reaction vessel and reacted at 120° C. until the epoxy equivalent had reached 1190. After cooling, 11 g of diethanolamine, 24 g of N-methylethanolamine, and 25 g of aminoethylethanolamine ketimide (79 weight % solution in MIBK) were added and the reaction was carried out at 110° C. for 2 hours. Thereafter, the reaction mixture was diluted with MIBK until the nonvolatile matter had become 80% to give a basal resin.

### Production Example 7

Preparation of a Crosslinking Agent

A reaction vessel equipped with a stirrer, condenser, nitrogen gas inlet pipe, thermometer, and dropping funnel was charged with 723 g of isophorone diisocyanate, 333 g of MIBK and 0.01 g of dibutyltin dilaurate and the temperature was raised to 70° C. After dissolving uniformly, 610 g of methyl ethyl ketoxime was added dropwise over 2 hours. After completion of dropping, with the reaction temperature of 70° C. being maintained and under IR spectrometric monitoring, the reaction was continued until the absorption due to the isocyanate group had disappeared to give a crosslinking agent (nonvolatile matter 80%).

### Production Example 8

Preparation of a Pigment Dispersion Paste

Using a sand grind mill, 60.0 g as solids of a pigment dispersant resin varnish (an epoxy quaternary ammonium salt type pigment dispersant resin), 2.0 g of carbon black, 100.0 g of kaolin, 80.0 g of titanium dioxide, 18.0 g of aluminum molybdate, and deionized water in such amount that the solid matter of the pigment paste became 56.0% were dispersed until a particle size of not more than 10 μm had been attained to give a pigment paste.

### Examples 1 to 4

On a solid matter basis, 627.2 g of the basal resin obtained in Production Example 6 and 234.2 g of the crosslinking agent obtained in Production Example 7 were evenly blended, and ethylene glycol mono-2-ethylhexyl ether was added at a level of 3% relative to solids.

To the mixture, 2.09 g of glacial acetic acid and 11.2 g of formic acid were added so as to attain a neutralization rate of 41.7%, and the whole mixture was gradually diluted by addition of deionized water. Then, the MIBK was distilled off under reduced pressure until the solid content had reached 36.0% to give a main emulsion.

A cationic electrodeposition coating of 20% solids was then prepared by admixing 791.7 g of the main emulsion obtained above, 30 g of the phosphonium group-containing compound obtained in Production Example 1, 2, 3 or 4, 178.6 g of the pigment dispersion paste obtained in Production Example 8, 999.7 g of deionized water, and 1%, relative to solids, of dibutyltin oxide.

### Comparative Example 1

A cationic electrodeposition coating of 20% solids was prepared by admixing 833.3 g of the main emulsion obtained in Example 1, 178.6 g of the pigment dispersion paste according to Production Example 8, 999.7 g of deionized water, and 1%, relative to solids, of dibutyltin oxide.

Evaluation of Corrosion Resistance

In each of the cationic electrodeposition coatings obtained in Examples 1 to 4 and Comparative Example 1, a cold-rolled steel panel of 150×70×0.8 mm, which had been subjected to chemical conversion treatment with Surfdyne SD 2500 (zinc phosphate surface treating agent, product of Nippon Paint Co.) in advance was dipped to carry out cationic electrodeposition coating to attain a dry film thickness of 20 μm.

On the test panel thus prepared, a cross-cut reaching the substrate was made with a knife and placed in a salt spray tester at 35° C. for 1000 hours, and the width of the rust or blister from the cut was measured.

When evaluated using a maximum rust or blister width of 6 mm as the standard, the samples obtained by using the coatings according to Examples 1 to 4 were acceptable but the sample obtained by using the coating of Comparative Example 1 was not acceptable.

### Production Example 9

Production of a Resin for Cationic Electrodeposition Coating Composition Containing a Sulfoniuim Group, a Propargyl Group, and a Long-chain Unsaturated Hydrocarbon Group

A reaction vessel equipped with a stirrer, condenser, nitrogen gas inlet pipe, thermometer, and dropping funnel was charged with 100.0 g of YDCN-701 (epoxy equivalent 200.4; cresol novolak epoxy resin; product of Tohto Chemical), 13.5 g of propargyl alcohol, and 0.2 g of dimethylbenzylamine and the temperature was increased to 105° C. The reaction was carried out for 1 hour to give a propargyl group-containing resin with an epoxy equivalent of 445. To this resin, 50.6 g of linoleic acid and an additional 0.1 g of dimethylbenzylamine were added and the reaction was further continued at the same temperature for 3 hours to give a resin containing a propargyl group and a long-chain unsaturated hydrocarbon group with an epoxy equivalent of 2100. Further, the resin was added with 10.6 g of SHP-100 (1-(2-hydroxyethylthio)-2-propanol; product of Sanyo Chemical Ind., Ltd.), 4.7 g of glacial acetic acid, and 7.0 g of deionized water and the reaction was carried out at a constant temperature of 75° C. for 6 hours. After confirming that the residual acid value was not more than 5, 62.9 g of deionized water was added, whereby the objective resin solution was obtained (nonvolatile matter 69.3%, sulfonium value 23.5 mmol/100 g varnish).

### Examples 5 to 8

Using a high-speed rotary mixer, 137.1 g of the resin for a cationic electrodeposition coating containing a sulfonium group, a propargyl group and a long-chain unsaturated hydrocarbon group obtained in Production Example 9 as the basal resin, 1.0 g of acetylacetonato-nickel, 0.6 g of methylaminoethanol, and 154.1 g of deionized water were stirred together for 1 hour. Then, an additional 370.5 g of deionized water and 10 g of the phosphonium group-containing compound obtained in Production Example 1, 2, 3 or 4 were added so as to attain a solid matter concentration of 15 weight % for use as an electrodeposition coating.

### Comparative Example 2

Using a high-speed rotary mixer, 144.3 g of resin for a cationic electrodeposition coating containing a sulfonium group, a propargyl group and a long-chain hydrocarbon group obtained in Production Example 9 as the basal resin, 1.0 g of acetylacetonato-nickel, 0.6 g of methylaminoethanol, and 154.1 g of deionized water were stirred for 1 hour. Then, an additional 373.3 g of deionized water was added so as to attain a solid matter concentration of 15 weight % for use as an electrodeposition coating.

Evaluation of Corrosion Resistance

Except that the cationic electrodeposition coatings obtained in Examples 5 to 8 and Comparative Example 2 were respectively applied so as to attain a dry film thickness of 15 μm and that baking was carried out for 25 minutes, the preparation and corrosion resistance evaluation of tests panels were performed in the same manner as in Example 1. As a result, whereas the samples obtained by using the coatings according to Examples 5 to 8 were acceptable, the sample obtained by using the coating according to Comparative Example 2 was not acceptable.

It is clear from the above results that the cationic electrodeposition coatings of Examples 5 to 8 to which the phosphonium group-containing compound was added were higher in corrosion prevention property than the coating to which no phosphonium-group containing compound was added.

1. A cationic electrodeposition coating composition
which comprises a water-soluble or water-dispersible phosphonium group-containing compound having a group represented by the following formula (1): 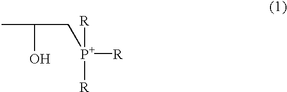
in the formula, R groups may be the same or different and each represents an alkyl group or a hydroxyalkyl group and at least one of R groups is a hydroxyalkyl group.

2. A cationic electrodeposition coating composition
which comprises a water-soluble or water-dispersible phosphonium group-containing compound having an epoxy compound as a basal skeleton and containing a phosphonium group to which at least one hydroxyalkyl group is linked.

3. A cationic electrodeposition coating composition
which comprises a water-soluble or water-dispersible phosphonium group-containing compound obtained by reacting an epoxy compound with a phosphine compound having at least one hydroxyalkyl group.

4. The cationic electrodeposition coating composition according to claim 1, 2 or 3
wherein the phosphonium group-containing compound accounts for 0.5 to 10 weight % relative to the resin solids of the cationic electrodeposition coating composition.

5. The cationic electrodeposition coating composition according to any of claims 1 to 4
which comprises an amine-modified epoxy resin and a blocked isocyanate curing agent.

6. The cationic electrodeposition coating composition according to claim 5
wherein the amine-modified epoxy resin contains an oxazolidone ring.

7. The cationic electrodeposition coating composition according to any of claims 1 to 4
which contains an unsaturated hydrocarbon group-containing sulfide-modified epoxy resin.

8. The cationic electrodeposition coating composition according to claim 7
wherein the unsaturated hydrocarbon group is a propargyl group.

9. The cationic electrodeposition coating composition according to claim 7
wherein the unsaturated hydrocarbon group has both a propargyl group and an unsaturated double bond.

10. The cationic electrodeposition coating composition according to any of claims 7 to 9
wherein the epoxy resin is a novolac epoxy resin.
